(19) United States
(12) Patent Application Publication
(10) Pub. No.: US 2019/0295412 A1
(43) Pub. Date: Sep. 26, 2019

(54) Operating Systems for Vehicles

(71) Applicant: Continental Automotive GmbH, Hannover (DE)

(72) Inventors: Stefan Grubwinkler, Massing (DE); Martin Beiderbeck, Parsberg (DE)

(73) Assignee: Continental Automotive GmbH, Hannover (DE)

(21) Appl. No.: 16/464,968

(22) PCT Filed: Nov. 30, 2017
(86) PCT No.: PCT/EP2017/081068

§ 371 Date: May 29, 2019

(30) Foreign Application Priority Data
Dec. 12, 2016 (DE) 10 2016 224 710.7
Jun. 8, 2017 (DE) 10 2017 209 667.5

(51) Int. Cl. G08G 1/052; G08G 1/01; B60W 40/09; B60W 30/095

(52) U.S. Cl. CPC G08G 1/052; G08G 1/0112; B60W 30/0956; G08G 1/0141; B60W 40/09; G08G 1/0129

(57) ABSTRACT

Various embodiments include a method for managing vehicle operation based on speed information comprising: acquiring speed information and location information from a multiplicity of networked vehicles; transmitting the speed information and location information to a server; determining speed distributions using the speed information received from a multiplicity of networked vehicles including forming characteristic numbers for characterizing the determined speed distributions; and storing the characteristic numbers in the server.

### CROSS-REFERENCE TO RELATED APPLICATIONS

This application is a U.S. National Stage Application of International Application No. PCT/EP2017/081068 filed Nov. 30, 2017, which designates the United States of America, and claims priority to DE Application No. 10 2017 209 667.5 filed Jun. 8, 2017 and DE Application No. 10 2016 224 710.7 filed Dec. 12, 2016, the contents of which are hereby incorporated by reference in their entirety.

### TECHNICAL FIELD

The present disclosure relates to operating vehicles. Various embodiments may include methods for storing speed information of vehicles in a backend, digital maps with stored speed information, and/or methods and systems for predicting vehicle speeds.

### BACKGROUND

Knowledge of the future speed trajectory of a particular vehicle along a planned route is necessary for numerous vehicle applications. For example, by virtue of knowledge of the expected driving speed trajectory, it is possible to improve the operating strategy of hybrid vehicles, adapt various vehicle functions to the individual driving behavior and estimate the energy demand for the planned route. According to the current state-of-the-art, in particular a surroundings sensor system, attributes of digital maps such as e.g. speed limits or bend radii, infastructure data (e.g. traffic light prediction data) and traffic information) are used to predict the expected speed profile.

US 2013/0274956 A1 describes a system in which speed profiles for sections of road are stored. For sections of road lying ahead on the route of a vehicle a target speed for this section of road and this vehicle are respectively determined using these stored profiles. It is estimated whether there is a high probability that the vehicle will exceed the determined target speed. In this case, vehicle systems are activated which, for example, cause the vehicle to be braked or a warning to be issued to the driver.

In addition, a system for predicting energy-relevant variables, such as e.g. vehicle speeds, along a route lying ahead is known. (Tobias Mauk: “Selbstlernende zuverlässigkeitsorientierte Prädiktion energetisch relevanter Größen im Kraftfahrzeug” [Self-learning reliability-oriented prediction of energetically relevant variables in a motor vehicle] dissertation, University of Stuttgart 2011). The described system is not based on the use of digital maps but rather on a self-training system in the vehicle for routes which are repeatedly traveled along.

When the speed trajectory is predicted solely using a surroundings sensor system, the prediction horizon is limited owing to the range of the sensor system which is used (camera, radar). Information from infrastructure data (e.g. traffic lights) is generally available locally only to a limited degree. Attributes of digital maps are frequently suitable for predicting the expected speed profile only to a restricted degree since on many route sections the maximum speed cannot be reached owing to the necessary braking operations. This relates particularly to urban sections of routes. The individual driving behavior also has an influence on the speed selected by the driver. Map attributes or traffic information generally do not permit conclusions to be drawn about the speed which is selected on a driver-specific basis.

### SUMMARY

The teachings of the present disclosure include improving the quality of prediction of future speed trajectories. The object is achieved by methods for storing speed information, digital maps, prediction systems, and/or methods for predicting vehicle speeds. For example, some embodiments include a method for storing speed information of vehicles (10) in a backend (12), having the steps: acquiring speed information (17, 18) and location information in a multiplicity of networked vehicles (10); transmitting the speed information (17, 18) and location information to a backend (12); determining speed distributions (20) using the speed information (17, 18), received from a multiplicity of networked vehicles (10), in the backend (12); characterized by the steps: forming characteristic numbers (Q) for characterizing the determined speed distributions (20) in the backend (12); and storing the characteristic numbers (Q), which characterize the speed distributions (20), in the backend (12).

In some embodiments, speed information (17, 18) is respectively acquired from the networked vehicles (10) and transmitted to the backend (12), which information contains the speeds (17) at which the networked vehicles (10) are instantaneously traveling at defined, spatially fixed points (15).

In some embodiments, in addition minimum and/or maximum speed values (18) which the networked vehicles (10) have reached since passing the preceding defined spatially fixed point (15) are acquired and transmitted.

In some embodiments, the acquired and transmitted speed information (17, 18) also contains route information.

In some embodiments, the speed information (17, 18) of the networked vehicles (10) is aggregated in the backend (12), and the speed distribution (20) and the characteristic numbers (Q) are continuously updated on the basis thereof.

As another example, some embodiments include a method for predicting vehicle speeds having the steps: predicting a vehicle route, and predicting the vehicle speed along the predicted route using characteristic numbers (Q) which are determined with a method as claimed in one of the preceding claims, which are stored in a backend (12), and which characterize the speed distribution (20) at spatially fixed points (15) along the predicted route.

In some embodiments, the prediction of the vehicle speed is carried out in the backend (12) or in the vehicle (10).

In some embodiments, the individual driving behavior of the driver (30) and/or vehicle-internal signals (33) are taken into account.

In some embodiments, the predicted vehicle route is subdivided as a function of its distance from the instantaneous vehicle position, and wherein the prediction of the speed for an imminent partial route is made taking into account vehicle-internal signals (33), while the prediction for a partial route which lies further away takes into account vehicle-internal signals (33) to a lesser extent, or not at all.

In some embodiments, speed values at which the driver travels are compared with characteristic numbers which have been generated with a method as described above and stored in the backend.

As another example, some embodiments include a digital map (14) having stored characteristic numbers (Q) for characterizing speed distributions (20) which are traveled at positionally fixed points (15) and which are determined and/or updated using a method as described above.

As another example, some embodiments include a prediction system for predicting vehicle speeds, comprising a backend (12) having at least one receiver device (121) for receiving speed information from networked vehicles (10), one evaluation device (122) for evaluating the speed information received from the networked vehicles, in order to calculate distribution functions (20) and characteristic numbers (Q) which characterize the distribution functions (20), using the information received from the networked vehicles (10), one storage device (124) for storing at least the characteristic numbers (Q) of the distribution functions (20), and one transmitter device (125) for transmitting stored characteristic numbers or calculated information to networked vehicles (10).

In some embodiments, the evaluation device (122) is also configured to link the speed information, distribution functions (20) or characteristic numbers (Q) to location data.

In some embodiments, there is a route prediction device (102) for predicting a route which will be traveled on in the future by a vehicle (10).

In some embodiments, there is a speed prediction device (123, 103) for predicting the vehicle speed along a vehicle route predicted with the route prediction device (102), according to a method as described above.

### BRIEF DESCRIPTION OF THE DRAWINGS

In the following, the teachings are explained in more detail by way of example with reference to FIGS. 1 to 5. In the figures, in each case schematically:

FIG. 1: shows an exemplary illustration of the system architecture of the prediction system incorporating teachings of the present disclosure;

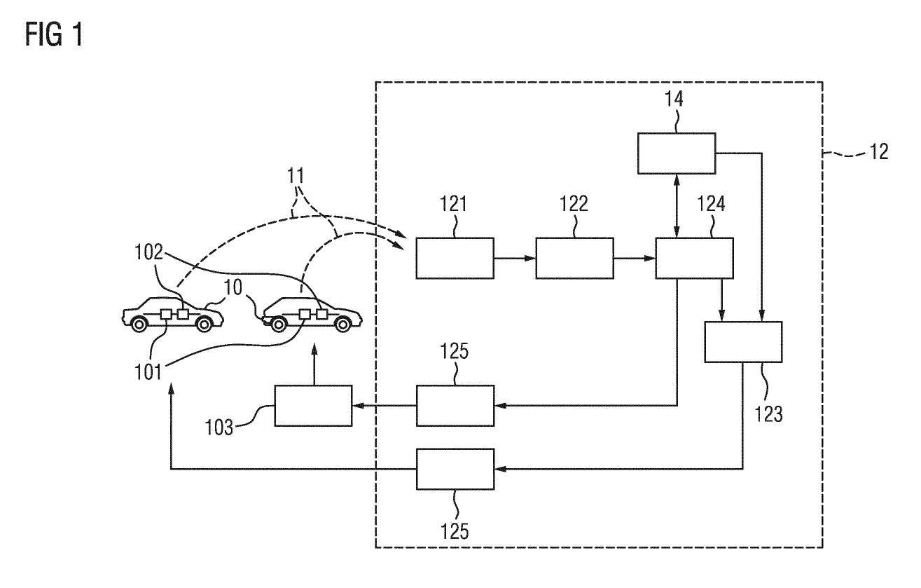

FIG. 2: shows an illustration of the data collection according to an embodiment of the method incorporating teachings of the present disclosure;

FIG. 3: shows an illustration of the data aggregation according to an embodiment of the method incorporating teachings of the present disclosure;

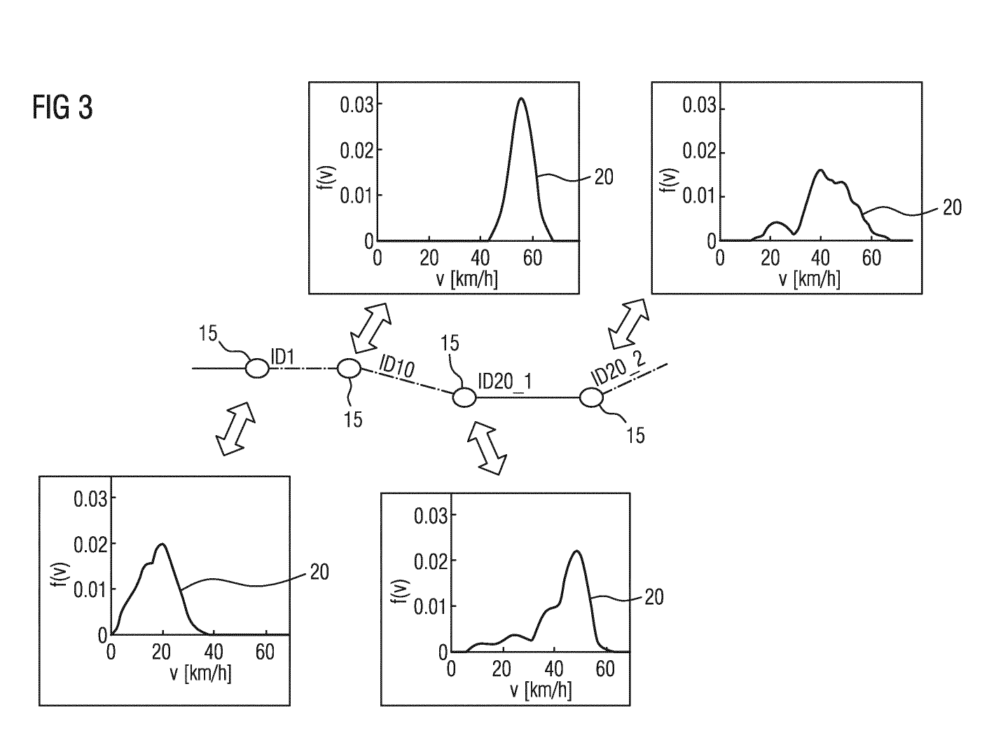

FIG. 4: shows an exemplary description of a speed profile with characteristic numbers; and

FIG. 5: shows an illustration of the method and system for predicting vehicle speeds incorporating teachigns of the present disclosure.

### DETAILED DESCRIPTION

Some embodiments include methods for storing speed information wherein speed information and location information are acquired in a multiplicity of networked vehicles and transmitted to a backend. In the backend, speed distributions are calculated therefrom and characteristic numbers for characterizing the determined speed distributions are formed therefrom. The characteristic numbers are stored in the backend.

The networked vehicles may comprise motor vehicles, such as e.g. hybrid vehicles, electric vehicles or vehicles with an internal combustion engine. In some embodiments, they have a location-determining system, e.g. a satellite navigation system, and a communication device. The communication device is configured for the (wireless) transmission of speed information and location information to a backend. In this context, the networked vehicles are used, as it were, as test vehicles in order to record speed distributions and transmit them to the backend. A database which can be used to predict future vehicle speeds is set up in the backend. The networked vehicles can, however, also benefit from an already present database during the prediction of their speed trajectory. In this case, they also have a receiver device in order to be able to receive data from the backend.

A backend comprises at least one receiver unit, one storage unit, one evaluation unit, and one transmitter unit. A backend can be a central backend server or else be implemented in a decentralized fashion in a Cloud. In some embodiments, the back-end stores a digital map database with location information and road information.

Statistical speed distributions are first calculated in the evaluation unit of the backend using the speed and location information transmitted by the networked vehicles. Suitable characteristic numbers are determined for the speed distributions, said characteristic numbers characterizing the statistical speed distribution. Such characteristic numbers can be statistical characteristic numbers which are derived from the distribution function, such as e.g. a mean value, gradient, variation, standard deviation or quantiles. The characteristic numbers can be used to describe both the distribution of the speeds of all the networked vehicles and the individual deviation of individual speeds at which individual drivers travel, in relation to the general speed distribution. These speed distributions may be linked to location data. A speed distribution represents for example the distribution of the speeds at which the networked vehicles travel at a specific spatially fixed point.

In some embodiments, in the networked vehicles speed information which contains the speeds at which the networked vehicles are traveling instantaneously at defined, spatially fixed (geo-referenced) points is acquired and transmitted. The transmission of the speed information may be carried out at the defined, spatially fixed points. The linking of the speed information to the location data can already take place in the networked vehicles. In the backend, distribution functions or characteristic numbers relating to the speeds at which the vehicle travels at a fixed location are formed and linked to this location information.

The speed distributions and/or the characteristic numbers can be stored as additional attributes in digital map databases. In order to define the points, the road network of a digital map may be subdivided into spatially fixed points. The points can, for example, be distributed equidistantally. It is also possible to vary the distances between the points as a function of the type of road and the average speed or the permissible maximum speed. If the vehicle passes through a spatially fixed point, the current speed value at the respective point is transmitted to the backend.

In some embodiments, the minimum and/or the maximum speed value which the networked vehicles have reached since passing the preceding defined spatially fixed point are/is additionally acquired by the networked vehicles and transmitted to the backend. If, for example, a defined spatially fixed point lies at a road intersection with traffic lights, the vehicles generally come to a standstill at this intersection. However, the precise stopping point of a vehicle frequently does not lie directly at the intersection but rather is shifted therefrom by one or more vehicle lengths. These generally occurring and frequent stops of the vehicles would not be completely acquired solely by means of the the speeds at the defined, spatially fixed points themselves. By also transmitting the minimum speed since the last spatially fixed point is passed, it is therefore also possible to acquire other stopping points independently of their precise position.

In some embodiments, the acquired speed information which is transmitted to the backend also contains route information of the vehicle. This route information contains, for example, the information as to whether a vehicle is traveling straight ahead or is turning off. In fact, it has to be assumed that there will be a significant difference in the speed depending on whether the vehicle is traveling straight ahead or turning off. The collected speeds of turning-off vehicles and of vehicles traveling straight ahead may be combined in the backend in different distributions and characteristic numbers. Therefore, the accuracy of the speed distributions and characteristic numbers can be increased by making case differentiations between turning-off vehicles and vehicles which are traveling straight ahead.

Such separate speed distributions or characteristic numbers can also be created for other conditions which can influence the speed distribution provided that the corresponding conditions and information are acquired. Examples of this are different times of day, times of the year, weather conditions, and/or days of the week. These conditions can be acquired in the vehicle and transmitted to the backend, or collected directly in the backend, acquired and linked with the speed information.

In some embodiments, the speed distributions and characteristic numbers which are determined in the backend are updated continuously. That is to say, as soon as a networked vehicle transmits a speed value to the backend, this value is taken into account for the re-calculation of the speed distribution and correspondingly updated characteristic numbers are stored. The updating of the database is therefore carried out by means of iterative calculation of the speed distribution and characteristic numbers in a statistical or machine learning method. Newly acquired speed values are therefore also respectively included.

In some embodiments, tendencies in the calculation of the distributions and characteristic numbers may be acquired and stored. Temporary changes (e.g. roadworks) or continuous changes in the routing of the traffic which influences the speeds at which vehicles travel can therefore also be taken into account.

In some embodiments, a method for storing speed information of motor vehicles in the backend provides a data representation of collected driving profiles which can be used for numerous vehicle functions. The use of characteristic numbers has, inter alia, reduces the quantity of data compared with the storage of complete speed distributions. However, depending on the available storage capacity, the entire speed distribution, and/or the individual speed information and location information received by the networked vehicles can be additionally stored in the backend. In order to use the data, the location-related speed characteristic numbers which are stored in the maps can be transmitted back again into the vehicle. In particular, the relatively small data volume of the characteristic numbers may be advantageous here.

In some embodiments, a method for predicting vehicle speeds comprises predicting a vehicle route and predicting the vehicle speed along the predicted route using characteristic numbers which are determined and stored in the backend with the method according to the invention and which characterize the speed distribution at spatially fixed points along the predicted route. The prediction can be carried out in the backend or in the vehicle.

The prediction of the vehicle route may be carried out here, for example, in a known fashion by a driver inputting the destination in a navigation device or by a driver inputting a route. Another possibility is that routes which are frequently repeatedly traveled along, such as e.g. the path between the driver's place of work and their residence are detected using statistical methods. A navigation device is generally not used for such routes. For such journeys, the vehicle can be equipped, for example, with a self-learning system.

In some embodiments, the predicted route is used to detect the defined, spatially fixed points for which speed profiles or corresponding characteristic numbers are stored in the backend. The future speed trajectory of the vehicle is predicted on the basis of the characteristic numbers and the predicted route. The prediction of the route and/or of the speed trajectory can take place either in the vehicle or in the backend. Depending on where the prediction of the route or the speed trajectory takes place, the corresponding data are transmitted from the vehicle to the backend or from the backend to the vehicle. The use of characteristic numbers for characterizing the speed distributions may provide the quantity of data to be transmitted is small. Because of the small data volume to be transmitted, the method is cost-effective and fast. In addition, the possibility of transmitting the information for a relatively large prediction horizon is provided.

If the prediction takes place in the backend, data which characterize the predicted route may be first transmitted to the backend. In the backend, the speed profile of the vehicle is calculated using the route information and the stored characteristic numbers and transmitted to the vehicle. Finally, the speed profile is received by the vehicle. If the prediction takes place in the vehicle, only the characteristic numbers which characterize the speed distribution are transmitted from the backend and received by the vehicle. In this context, some or all of the characteristic numbers which lie along the route which is intended by the driver are transmitted.

In some embodiments, the individual driving behavior of the driver and/or vehicle-internal signals are taken into account. The individual driving behavior can be represented e.g. as a deviation from the general speed distribution. This deviation can also be expressed in the form of a characteristic number.

In some embodiments, the predicted vehicle route is subdivided as a function of its distance from the instantaneous vehicle position. The prediction of the vehicle speed for an imminent partial route with a short preview horizon (e.g. less than 200 m) is carried out taking into account (inter alia) vehicle-internal signals. In contrast, the prediction for a distant partial route with a relatively large preview horizon (e.g. >800 m) is carried out essentially using data stored in the backend. The greater the preview horizon, i.e. the distance from the current position of the vehicle, the fewer the vehicle-internal signals are taken into account for the speed prediction. In addition to the vehicle-internal signals, e.g. map data, the personal driving behavior and the stored characteristic numbers are used for the prediction. However, for a short preview horizon, the vehicle-internal signals are given a larger weighing than for a large preview horizon.

The characteristic numbers which are calculated and stored in the backend can also be used for a method for evaluating the driving behavior of a driver of a vehicle. For this, speed values at which the driver travels (e.g. at the spatially fixed points) are compared with the stored characteristic numbers. By comparing the speeds at which the driver travels with the characteristic numbers at various spatially fixed points, it is possible to generate for the individual driver and store a separate database which characterizes how quickly the driver is traveling in comparison with the general group (or in comparison with the networked vehicles included in the speed distribution). The deviation of individual driving behaviors from the general group can be described, for its part, by characteristic numbers, for example by quantiles. Throughout this application, the term “driver” is to be understood in a gender-neutral fashion and relates to both male and female drivers.

In some embodiments, a digital map includes stored characteristic numbers for characterizing speed distributions at which vehicles travel at spatially fixed points, which speed distributions are determined and/or updated with a method as described above. A digital map is a database with stored location information and road information, such as is used, for example, for (satellite) navigation devices. The digital map can be stored in a vehicle and/or in the backend.

The digital map may be a component of a prediction system for predicting vehicle speeds. In some embodiments, a prediction system for predicting vehicle speeds comprises a backend which can be located centrally on a server or can be implemented in a decentralized fashion, e.g. in a Cloud. The backend has at least one receiver device for receiving speed information from networked vehicles. In addition, the backend has an evaluation device for evaluating the speed information which is received from the networked vehicles, for calculating distribution functions, and characteristic numbers which characterize the distribution function. The backend additionally includes at least one storage device for storing at least the characteristic numbers of the distribution functions and a transmitter device for transmitting stored characteristic numbers or calculated information to networked vehicles. In some embodiments, the storage device comprises a database of an inventive digital map as described above. The evaluation device may link the speed information, distribution functions and/or characteristic numbers to location data.

The prediction system may comprise a route prediction device for predicting a route on which a vehicle will travel in future. The route prediction device can be implemented in the vehicle or in the backend. In addition, the prediction system may comprise a speed prediction device for predicting the vehicle speed along a vehicle route predicted with the route prediction device. Like the route prediction device, the speed prediction device can also be implemented either in the networked vehicle or in the backend.

Networked vehicles 10 transmit speed information, timestamps and the geo-position of the vehicles 10 to a backend 12 via a wireless connection 11. The data are acquired by means of suitable electronic unit 101 in the vehicle (e.g. OBD dongle, telematics unit). In the backend 12, the data are received by a receiver device 121. In an evaluation device 122 in the backend 12, the speed data are collected and aggregated. Using statistical methods and machine learning methods, in the backend 12 distribution functions relating to the collected speed information are formed for specific spatially fixed positions, along with suitable characteristic numbers Q for describing the speed distributions 20 and are stored in a storage device 124.

The speed distributions and/or the characteristic numbers are linked to location data and can be stored as additional information in digital maps 14. Since the speed distributions 20 and characteristic numbers Q are constantly updated, they can preferably be stored as dynamic additional data. In order to use the data, the location-related speed characteristic numbers Q which are stored in the digital maps 14 can be transmitted back again into the vehicle 10.

In some embodiments, all the characteristic numbers Q which lie along a route intended by the driver are transmitted. The intended route was determined here, for example, in the vehicle 10 by the inputting of the destination in a navigation device 102. The prediction of the speed trajectory is carried out in this case in a prediction device 103 in the vehicle 10 using the predicted route and the characteristic numbers Q received from the backend 12. In some embodiments, the characteristic numbers Q are used for other applications, such as for example for evaluating drivers. The use of characteristic numbers Q requires significantly less data to be transmitted for the respective use than for a complete distribution function.

In some embodiments, the prediction of the speed trajectory is carried out in the backend 12. The intended route can be predicted in the vehicle 10 or in the backend 12. In this case, however, the characteristic numbers Q along the route are not transmitted by a transmitter device 125 of the backend 12 to the vehicle 10, but rather the predicted speeds at the spatially fixed points 15 along the route are already transmitted. The prediction of the speeds is carried out here in the prediction unit 123 of the backend 12.

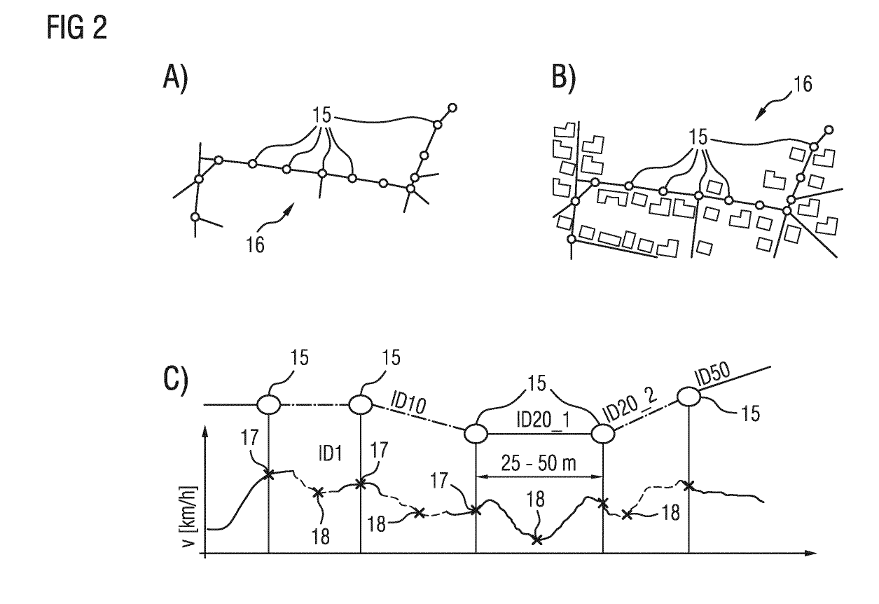

In some embodiments, the speed information is collected at constant, spatially fixed (geo-referenceable) points 15 which are, for example, at a fixed distance from one another (FIG. 2). In order to define the points 15, the road network 16 of a digital map 14 is subdivided into spatially fixed points 15 (FIG. 2 A) and B)). It is also possible to vary the distances between the points 15 as a function of the type of road and the maximum speed. If the vehicle 10 passes a spatially fixed point 15, the current speed value 17 at the respective point 15, and preferably the maximum and/or minimum speed value 18 since the last point 15, are transmitted to the backend 12 (FIG. 2 C)). For each spatially fixed point 15 in the backend 12, a distribution function 20 is calculated iteratively from the collected speed values (17, 18). Statistical methods such as core density estimators are applied for this. A separate distribution 20 is formed for all the values (17, 18)—that is to say a current, maximum and/or a minimum speed value.

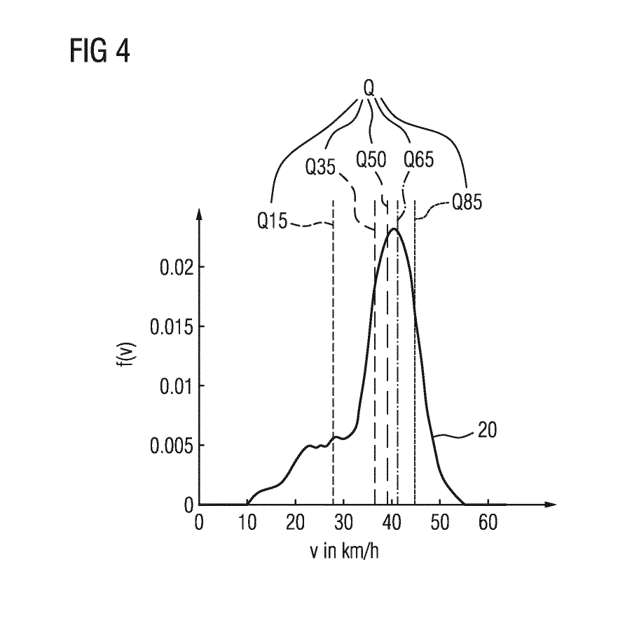

FIG. 4 shows a speed distribution 20, for example at a spatially fixed point 15. In order to describe the distributions, a plurality of quantiles Q are calculated in the backend (e.g. 15%/35%/50%/65%/85%—quantile). That is to say, for example, 15% of the speeds at which vehicles travel at this location (which speeds are also acquired) are below the 15% quantile Q15. 35% lie below the 35% quantile Q35 etc. As a result, the profile of the distribution 20 can be described by a limited number of characteristic numbers Q. The quantiles Q are also suitable for describing the general, location-independent, individual driving behavior 30 of a driver. For example, the speed value 17 of a driver with above-average speed is above the 50% quantile Q50 at all the spatially fixed points 15. Likewise, by using the quantiles Q it is possible to describe not only the location-independent influence of the driving behavior 30 but also the influence of further influencing factors 31 on the speed profile, such as for example visibility conditions, the traffic situation, weather conditions. An additional database in which the deviation from the average value (50% quantile) is stored is created for each of the influencing conditions (30, 31).

For specific spatially fixed points 15, for example intersections, different speed distributions 20 and corresponding characteristic numbers Q can also be created depending on the route profile which is being driven along. That is to say, it is possible to differentiate, for example, between the speed 17 of turning-off vehicles 10 and that of vehicles 10 which are traveling straight ahead.

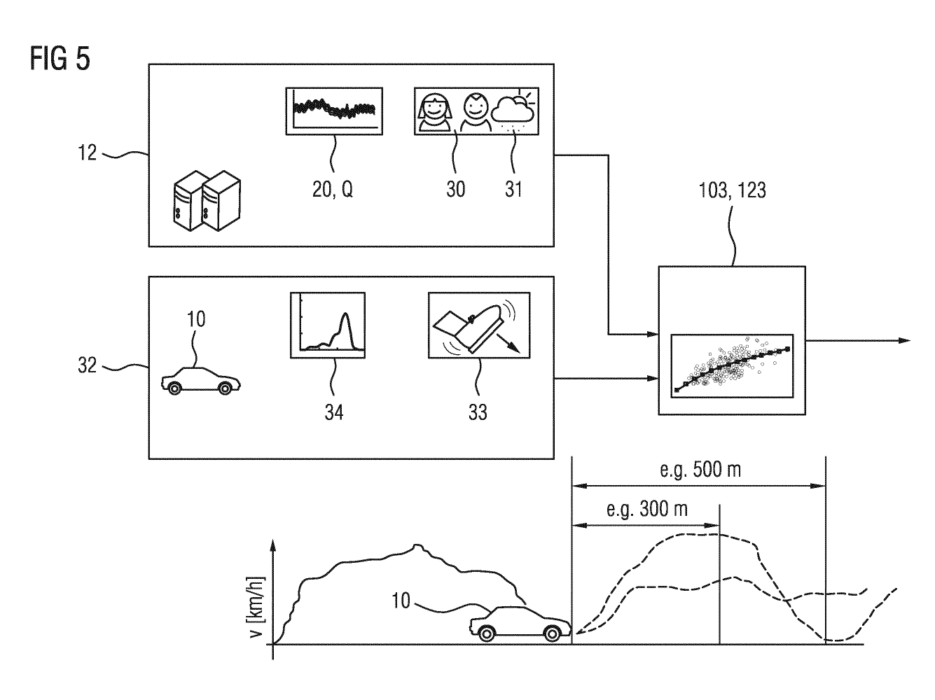

For the prediction of the speed trajectory in a speed prediction device 103, 123 of a vehicle 10, the expected speed value for a specific preview horizon (e.g. in 500m with respect to the current position of the vehicle) is predicted using the prediction method according to the invention. (FIG. 5) For this purpose, quantiles Q, from the backend, of the speed distribution for the route to be predicted and, if appropriate, average driver-specific deviations 30 and situation-specific deviations 31 from the expected average profile are used for the route to be predicted.

In addition, vehicle-internal data sources may be used, e.g., vehicle signals 33 at the current position (e.g. accelerator pedal position, current torque, brake pedal position, distance from the vehicle in front, . . . ), as well as the deviation of the speed profile of the preceding route in comparison with the speed distributions 20 or characteristic numbers Q stored in the backend. For this purpose, during the journey the current speed value is continuously compared with the speed distributions 20 or characteristic numbers Q collected in the backend 12.

Statistical models and machine learning methods may be used to predict the future speed trajectory. Different prediction models are used for different preview horizons. For example, a prediction model with a short preview horizon (e.g. 200m) therefore also uses vehicle-internal variables, while a prediction model for a relatively large prediction horizon (e.g. 800m) almost exclusively uses data collected in the backend 12.

The characteristic numbers Q in the backend 12 (quantiles) can be used to describe not only the most frequent value but also the entire speed distribution. The quantiles Q are suitable for making a location-independent description of driver-specific and situation-specific influencing factors. The method and system for predicting the speed trajectory on the basis of speed distributions 20 and characteristic numbers Q collected in the backend 12 make it possible to extend the prediction horizon considerably in comparison with known methods.

Speed values which are predicted with the prediction method can be applied as an input variable for the operating strategy of hybrid vehicles (possibly also electric vehicles and vehicles with an internal combustion engine). Further application examples are the evaluation of driving behavior (comparison of an individual driver in comparison with the general group) or the improvement of current digital maps or the creation of high-precision maps using the collected driving profiles (map refinement), the prediction of traffic influences, the improvement of navigation algorithms or range algorithms for electric vehicles; and the creation of additional features in digital maps (e.g. turning-off probabilities).

In addition, the methods and systems described herein can be used for all vehicle functions which are based on predicted speed profiles (e.g. autonomous driving, ACC, phased traffic light assistant).

What is claimed is:

1. A method for managing vehicle operation based on speed information, the method comprising:
acquiring speed information and location information from a multiplicity of networked vehicles;
transmitting the speed information and location information to a server;
determining speed distributions using the speed information received from a multiplicity of networked vehicles including
forming characteristic numbers for characterizing the determined speed distributions; and
storing the characteristic numbers in the server.

2. The method as claimed in claim 1, wherein the speed information includes instantaneous speed values gathered when the networked vehicles pass defined, spatially fixed points.

3. The method as claimed in claim 2, wherein the speed information includes minimum and/or maximum speed values reached by the networked vehicles since passing a preceding defined spatially fixed point.

4. The method as claimed in claim 1, wherein the speed information includes route information.

5. The method as claimed in claim 1, further comprising aggregating the speed information at the server and continuously updating the speed distribution and the characteristic numbers on the basis thereof.

6. The method as claimed in claim 1, further comprising:
predicting a vehicle route; and
predicting a speed for a particular vehicle traveling along the predicted route using the characteristic numbers.

7. The method as claimed in claim 6, wherein the prediction of the vehicle speed is carried out in the server.

8. The method for predicting the vehicle speed as claimed in claim 6, further comprising adapting the predicted speed based on individual driving behavior of the driver and/or vehicle-internal signals.

9. The method as claimed in claim 8, further comprising:
dividing the predicted vehicle route into subdivisions as a function of distance from the instantaneous vehicle position;
adapting the predicted speed for an imminent partial route based at least in part on vehicle-internal signals.

10. The method as claimed in claim 1, further comprising evaluating the driving behavior of a driver of a vehicle, by comparing speed values at which the driver travels with the characteristic numbers.

11. (canceled)

12. A prediction system for predicting vehicle speeds, the system comprising:
a receiver device for receiving speed information from networked vehicles;
a processor programmed to evaluate the speed information received from the networked vehicles and to calculate distribution functions and characteristic numbers corresponding to the distribution functions using the information received from the networked vehicles;
a memory for storing the characteristic numbers of the distribution functions; and
a transmitter device for transmitting stored characteristic numbers or calculated information to networked vehicles.

13. The prediction system as claimed in claim 12, wherein the processor is programmed to link the speed information, distribution functions, and or characteristic numbers to location data.

14. The prediction system as claimed in claim 12, wherein the processor is programmed to predict a route which will be traveled on in the future by a particular vehicle.

15. The prediction system as claimed in claim 14, wherein the processor is programmed to predict a speed of a particular vehicle along a vehicle route predicted with the route prediction device.
